(19) United States
(12) Patent Application Publication
(10) Pub. No.: US 2023/0203249 A1
(43) Pub. Date: Jun. 29, 2023

(54) POLYIMIDE-BASED COMPOSITION AND POLYIMIDE FILM

(71) Applicant: DONGJIN SEMICHEM CO., LTD., Incheon (KR)

(72) Inventors: Jae Hoon JUNG, Hwaseong-si (KR); Jin Wuk KIM, Hwaseong-si (KR); Dong Min KIM, Hwaseong-si (KR); Young Ho SEO, Hwaseong-si (KR); Young Woon CHO, Hwaseong-si (KR); Hwi Young YUN, Hwaseong-si (KR); Nam Hee HWANG, Hwaseong-si (KR)

(21) Appl. No.: 18/089,140

(22) Filed: Dec. 27, 2022

(30) Foreign Application Priority Data
Dec. 29, 2021 (KR) 10-2021-0191699

(51) Int. Cl. C08G 73/10; C08J 5/18; C09D 179/08; C09D 7/20

(52) U.S. Cl. CPC C08G 73/1042; C08G 73/1067; C08G 73/1064; C08G 73/1032; C08J 5/18; C09D 179/08; C09D 7/20; C08J 2379/08

(57) ABSTRACT

A polyimide-based composition includes a polyimide precursor and a solvent, in which the polyimide precursor includes repeating units represented by Chemical Formula 1 to 3. A polyimide film is also made from the composition.

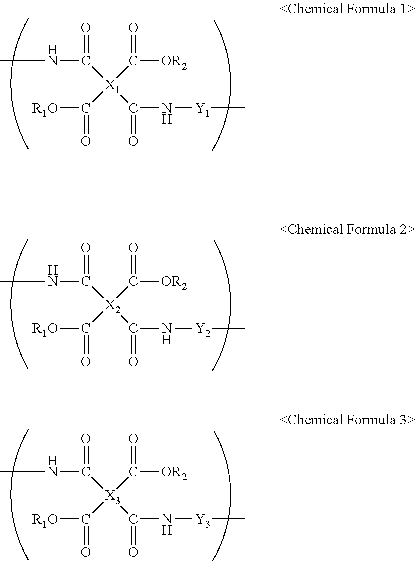

### CROSS REFERENCE TO RELATED APPLICATION

The present application claims priority to Korean Patent Application No. 10-2021-0191699, filed Dec. 29, 2021, which is incorporated herein by reference in its entirety.

### BACKGROUND

### 1. Technical Field

The present disclosure relates to a polyimide-based composition and a polyimide film and, more particularly, to a transparent polyimide varnish composition including a non-halogen substance for flexible display substrates and a polyimide film prepared using the same.

### 2. Description of the Related Art

With increasing market demand for flexible displays, the development of flexible substrate materials is being increasingly performed. Most of the recently released curved or foldable mobile phones use a polyimide film as a thin film transistor (TFT) substrate and have a top emission structure. The implementation of the top emission structure is relatively easy with small panels but are difficult with large panels. The positive electrode of an OLED device is made of a metal such as Ag, and the resistance of the positive electrode needs to be reduced for uniform emission over a large area. When the thickness of the positive electrode metal is increased to reduce the resistance, there is a problem in that the transmittance decreases. To overcome this problem, large-scale OLED displays have a bottom emission structure. However, the existing colored polyimide has a low transmittance (i.e., a high yellow index), it is difficult to use the colored polyimide for a bottom emission flexible substrate. Moreover, because the process temperature for TFTs is 350° C. or higher, a transparent polyimide substrate exhibiting a small hysteresis gap at high temperatures (350° or higher) is required to achieve a large scale flexible OLED display.

On the other hand, a polyimide varnish material containing a halogen element such as bromine or fluorine is known to exhibit excellent optical and thermal characteristics. However, the use of such a halogen-containing compound along with a low-temperature polycrystalline silicon (LIPS) process, there are problems in that a bake process of 450° C. or higher is required and the halogen-containing compound does not satisfy the required transparency and thermal resistance.

In addition, the use of such a halogen-containing material has a problem of generating toxic gases such as dioxin-based compounds when the material burns. Therefore, a reduction in halogen is desperately required for electronic material compositions.

### SUMMARY

An objective of the present disclosure is to provide a polyimide-based composition and a polyimide film having good thermal characteristics in terms of glass transition temperature (Tg) and thermal expansion coefficient (CTE)) and good optical characteristics in terms of yellowness index (YI).

Another objective of the present disclosure is to provide a halogen-containing polyimide-based composition and a polyimide film to which a high-temperature bake process performed at 450° C. or higher is applicable.

The above-mentioned objectives and other objectives will be described in detail below.

To achieve the objectives, in an embodiment, a polyimide-based composition may include a polyimide precursor and a solvent, the polyimide precursor including repeating units represented by Chemical Formulas 1 to 3.

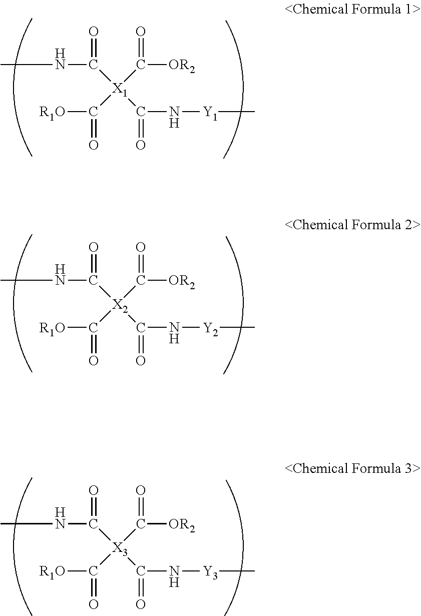

In Chemical Formulas 1 to 3,

X1 to X3 are tetravalent organic groups derived from a dianhydride monomer, Y1 to Y3 are divalent organic groups derived from a diamine monomer,

at least one of X1 to X3 includes a structure derived from a pyromellitic dianhydride,

Y1 to Y3 include a structure derived from at least one diamine monomer selected from the group consisting of aromatic diamines containing a fluorene group, aromatic diamines containing a sulfonyl group, and aromatic diamines containing a halogenoalkyl substituent, in which Y1 to Y3 are different structures from each other, and

R1 and R2 are each independently hydrogen, deuterium, a substituted or unsubstituted C1-C30 alkyl group, a substituted or unsubstituted C2-C30 alkenyl group, a substituted or unsubstituted C6-C50 aryl group, or a substituted or unsubstituted C2-C50 heteroaryl group.

In another aspect, a polyimide film formed from the polyimide-based composition is provided.

According to the present disclosure, the polyimide-based composition and the polyimide film have improved thermal characteristics (for example, high glass transition temperature (Tg) and low coefficient of thermal expansion (CTE)) and improved optical characteristics (for example, low yellowness index (YI)).

In addition, the composition and film have a low halogen content so that the composition and film are applicable to high-temperature bake processes performed at or above 450° C.

The above objectives and other objectives will be described in detail below.

### DETAILED DESCRIPTION

Prior to a description of the present disclosure, it should be noted that the tams used in the present specification are used only to describe specific examples and are not intended to limit the scope of the present disclosure which will be defined only by the appended claims. Unless otherwise defined herein, all terms including technical and scientific terms used herein have the same meaning as commonly understood by those who are ordinarily skilled in the art to which the present disclosure pertains.

Unless otherwise stated herein, it will be further understood that the terms “comprise”, “comprises”, and “comprising”, when used in this specification, specify the presence of stated features, regions, integers, steps, operations, elements and/or components but do not preclude the presence or addition of one or more other features, regions, integers, steps, operations, elements, components, and/or groups thereof.

Throughout the specification and claims of the disclosure, the term “aryl” refers to a functional group having a C5-50 aromatic hydrocarbon ring, and examples thereof include phenyl, benzyl, naphthyl, biphenyl, terphenyl, fluorene, phenanthrenyl, triphenylenyl, perylenyl, chrysenyl, fluoranthenyl, benzofluorenyl, benzotriphenylenyl, benzochrysenyl, anthracenyl, stilbenyl, or pyrenyl.

The term “heteroaryl” refers to a C2-50 aromatic ring structure containing at least one heteroatom, and it includes a heterocyclic ring such as pyrrolyl, pyrazinyl, pyridinyl, indolyl, isoindolyl, furyl, benzofuranyl, isobenzofuranyl, dibenzofuranyl, benzothiophenyl, dibenzothiophenyl, quinolyl group, isoquinolyl, quinoxalyl, carbazolyl, phenanthridinyl, acridinyl, phenanthrolinyl, thienyl, pyridine ring, pyrazine ring, pyrimidine ring, pyridazine ring, triazine ring, indole ring, quinoline ring, acridine ring, pyrrolidine ring, dioxane ring, piperidine ring, morpholine ring, piperazine ring, carbazole ring, furan ring, thiophene ring, oxazole ring, oxadiazole ring, benzofuran ring, triazole ring, thiadiazole ring, benzothiophene ring, triazole ring, imidazole ring, benzoimidazole ring, pyran ring, and dibenzofuran ring.

In chemical formulas: Arₓ (where x is an integer) means a substituted or unsubstituted C6-C50 aryl group, or a substituted or unsubstituted C2-C50 heteroaryl group, unless otherwise defined; Lₓ (where x is an integer) means, a direct bond, substituted, or unsubstituted C6-C50 arylene group, or a substituted or unsubstituted C2-C50 heteroarylene group, unless otherwise defined; and Rₓ (x is an integer), means a hydrogen, deuterium, halogen, a nitro group, a nitrile group, a substituted or unsubstituted C1-C30 alkyl group, a substituted or unsubstituted C2-C30 alkenyl group, a substituted or unsubstituted C1-C30 alkoxy group, a substituted or unsubstituted C1-C30 sulfide group, a substituted or unsubstituted C6-C50 aryl group, or a substituted or unsubstituted C2-C50 heteroaryl group, unless otherwise defined.

Throughout the present specification and claims, the term “substituted or unsubstituted” means that a portion is substituted or unsubstituted by at least one selected from the group consisting of deuterium, halogen, amino groups, cyano groups, nitrile groups, nitro groups, nitroso groups, sulfamoyl groups, isothiocyanate groups, thiocyanate groups, carboxyl groups, carbonyl groups, C1-C30 alkyl groups, C1-C30 alkylsulfinyl groups, C1-C30 alkylsulfonyl groups, C1-C30 alkylsulfanyl groups, C1-C12 fluoroalkyl groups, C2-C30 alkenyl groups, C1-C30 alkoxy groups, C1-C12 N-alkylamino groups, C2-C20 N,N-dialkylamino groups, substituted or unsubstituted C1-C30 sulfide groups, Cl-C6 N-alkylsulfamoyl groups, C2-C12 N,N-dialkylsulfamoyl groups, C0-C30 silyl groups, C3-C20 cycloalkyl groups, C3-C20 heterocycloalkyl groups, C6-C50 aryl groups, C3-050 heteroaryl groups, etc. In addition, the same symbols throughout the present specification may have the same meaning unless otherwise specified. On the other hand, * means a binding position.

All or some embodiments described herein may be combined and configured so that the embodiments may be modified in various ways unless the context clearly indicates otherwise. Hereinafter, embodiments of the present invention and the effects thereof will be described in detail below.

Hereinafter, the present invention will be described in detail.

A polyimide-based composition according to an embodiment of the present disclosure includes: a polyimide precursor including repeating units represented by Chemical Formulas 1, 2, and 3; and a solvent.

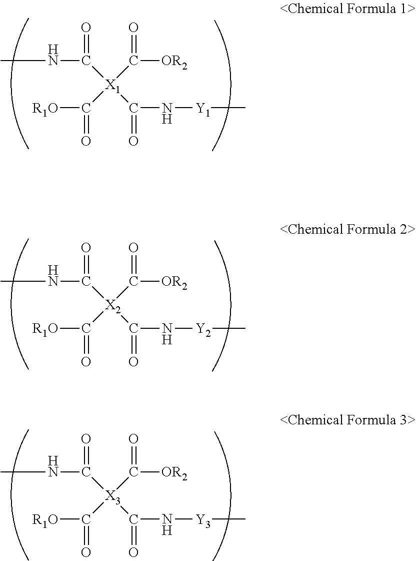

In Chemical Formulas 1 to 3,

X1 to X3 are tetravalent organic groups derived from a dianhydride monomer,

Y1 to Y3 are divalent organic groups derived from a diamine monomer,

at least one of X1 to X3 includes a structure derived from a pyromellitic dianhydride,

Y1 to Y3 include a structure derived from at least one diamine monomer selected from the group consisting of aromatic diamines containing a fluorene group, aromatic diamines containing a sulfonyl group, and aromatic diamines containing a halogenoalkyl substituent, in which Y1 to Y3 are different structures from each other, and

R1 and R2 are each independently hydrogen, deuterium, a substituted or unsubstituted C1-C30 alkyl group, a substituted or unsubstituted C2-C30 alkenyl group, a substituted or unsubstituted C6-C50 aryl group, or a substituted or unsubstituted C2-C50 heteroaryl group.

The polyimide precursor may include 5% to 15% by weight of fluorine.

The inventors have confirmed that a high molecular weight polyamic acid solution can be obtained when the content of aromatic diamine containing a fluorene group is high, and a polyimide film obtained by thermal imidization of the polyamic acid solution has a high glass transition temperature (Tg).

In addition, the inventors have found that when the content of aromatic diamine containing a sulfonyl group is high, a low molecular weight polyamic acid solution can be obtained, and a polyimide film obtained by thermal imidization of the polyamic acid solution has excellent optical and thermal characteristics.

The problem is that the polyimide film applied used in the LTPS process requires excellent thermal characteristics in terms of coefficient of thermal expansion (CTE) and glass transition temperature (Tg) and excellent optical characteristics in terms of yellowness index (YI). To solve this problem, the content of aromatic diamines containing fluorene groups, diamines containing sulfonyl groups, and diamines containing halogenoalkyl substituents was controlled. This polyamic acid solution was applied by a coating process and subjected to thermal imidization to obtain a polyimide film. Thus, a transparent polyimide film having satisfactory thermal characteristics (CTE and Tg) and a satisfactory yellowness index (YI) was produced.

Importance in tams of composition is that the content of aromatic diamines containing fluorene groups need not be excessive.

The content of aromatic diamines containing fluorene groups and aromatic diamines containing sulfonyl groups needs to be controlled to obtain a film satisfying a yellowness index of 20 or less, a Tg of 450° C. or higher, a CTE of 20 ppm/° C. or less, and a weight average molecular weight in a range of 50,000 to 150,000. Since diamines having a halogenoalkyl substituent having a relatively low charge transfer complex (CTC) value is poor in thermal characteristics, aromatic diamines containing relatively heat-resistant functional groups such as fluorene and sulfonyl were used, and the content thereof was controlled. Therefore, the film with satisfactory thermal characteristics and optical characteristics could be obtained.

The weight average molecular weight of the polyimide precursor is preferably within the range of 50,000 to 150,000. When the range is satisfied, thermal and optical characteristics are improved.

In addition, the molar ratio of structures derived from the aromatic diamines containing a sulfonyl group to structures derived from the pyromellitic dianhydrides is in a range of 1:0.20 to 1:0.60.

In addition, the structures derived from the pyromellitic dianhydrides (PMDA) account for 60% to 80% by mole of the total mole of the structures derived from all dianhydrides in X1 to X3. In addition, the structures derived from dianhydrides containing two or more aromatic rings account for 20% to 40% by mole of the total mole of the structures derived from all the dianhydrides in X1 to X3.

In addition, the aromatic diamines containing a fluorene group account for 20% to 50% by mole of the total mole of the structures derived from all the diamines in Y1. In addition, the aromatic diamines containing a sulfonyl group account for 5% to 25% by mole of the total mole of the structures derived from all the diamines in Y1 to Y3. In addition, the aromatic diamines containing a halogenoalkyl substituent account for 40% to 60% by mole of the total mole of the structures derived from all the diamines in Y1 to Y3.

As seen from the examples described below, the thermal and optical characteristics are excellent when the conditions described above are satisfied.

The diamine monomer containing a halogenoalkyl substituent may be one or more selected from the group consisting of 2,2′-bis(trifluoromethyl) benzidine (FMB), 2,2-bis[4-(4-aminophenoxy) phenyl]hexafluoropropane (HFBAPP), 2,2-bis(3-amino-4-hydroxyphenyl) hexafluoropropane (BIS-AP-AF), and 1,3-diamino-2,4,5,6-tetrafluorobenzene (DRFB).

The aromatic diamine containing a sulfonyl group may be one or more selected from the group consisting of 4,4′-diaminodiphenyl sulfide (ASD), 4,4′-diaminodiphenyl sulfone (DDS), bis[4-(4-aminophenoxy)phenyl]sulfone (BAPS), and 2,2-bis[4-(3-aminophenoxy) benzene]sulfone (m-BAPS).

In addition, the dianhydride containing two or more aromatic rings may be one or more selected from the group consisting of 3,3′,4,4′-benzophenonetracarboxylic dianhydride (BTDA), 3,3′,4,4′-biphenyl tetracarboxylicacid dianhydride (BPDA), 2,2-bis(3,4-anhydrodicarboxyphenyl)-hexafluoropropane dianhydride (6FDA), and 4,4′-oxydiphthalic anhydride (ODPA), and 3,3′,4,4′-diphenylsulfone-tetracarboxylic dianhydride (DSDA).

The solvent may be one or more selected from the group consisting of: amide solvents such as dimethylformamide (DMF), dimethylacetamide (DMAC), and n-methylpyrrolidone (NMP); ketone solvents such as acetone, methyl ethyl ketone (MEK), methyl isobutyl ketone (MIBK), cyclopentanone, and cyclohexanone; ether solvents such as tetrahydrofuran (THF), 1,3-dioxolane and 1,4-dioxane; symmetrical glycoldiethers such as methyl acetate, ethyl acetate, butyl acetate, γ-butyrolactone, α-acetic lactone, β-propiolactone, δ-valerolactone, methyl monoglyme(1,2-dimethoxyethane), methyldiglyme(bis(2-methoxyethyl)ether), methyltriglyme(1,2-bis(2-methoxyethoxy)ethane), methyltetraglyme(bis[2-(2-methoxyethoxyethyl)]ether), ethyl monoglyme(1,2-diethoxyethane), ethyl diglyme(bis(2-ethoxyethyl)ether), and butyl diglyme(bis(2-butoxyethyl) ether); and other ethers such as dipropylene glycol methyl ether, tripropylene glycol methyl ether, propylene glycol n-propyl ether, dipropylene glycol n-propyl ether, propylene glycol n-butyl ether, dipropylene glycol n-butyl ether, tryrene glycol n-propyl ether, Propylene glycol phenyl ether, dipropylene glycol dimethyl ether, 1,3-dioxolane, ethylene glycol monobutyl ether, diethylene glycol monoethyl ether, diethylene glycol monobutyl ether, and ethylene glycol monoethyl ether.

Hereinafter, the present disclosure will be described in greater detail with reference to synthesis examples of compounds and preparation examples of OLEDs. The synthesis examples and preparation examples described below are presented only for illustrative purposes and the scope of the present disclosure is not limited to the examples.

### Method of Measuring Optical Characteristics of PI Film

Films with a thickness in a range of 10 to 15 μm were manufactured, and the yellowness index (YI) of each film was measured using a transmittance meter (COH-400, manufactured by Nippon Denshoku Industries Co., Ltd.).

### Method Of Measuring Optical and Thermal Characteristics of PI Film—Coefficient of Thermal Expansion (CTE)

The coefficient of thermal expansion (CTE) of each film was measured using a thermal distortion analysis (TMA) method. Samples had a thickness in a range of 8 to 12 μm and a size of 5 mm by 16 mm. The measurement was performed in a nitrogen atmosphere with a nitrogen flow rate of 50 mL/min. After reaching equilibrium at 50° C., the temperature was raised at a rate of 10° C./min, and the raised temperature was maintained for 30 minutes. Next, the temperature was lowered to 50° C. and was then raised 500° C. at a rate of 10° C./min. CTE was measured from a temperature zone of 100° C. to 430° C. in the second temperature elevation graph of the obtained graphs.

### Method of Calculating Fluorine Content

The proportion of fluorine in monomer X the proportion of fluorine monomer during synthesis X 100% by weight

### Comparative Example 1 (PMDA 90% By Mole)

To a 1000 mL three-necked round-bottom flask substituted with nitrogen gas, 425 g of N-methyl-2-pyrrolidone (NMP) was added. In addition, 24.08 g (0.8 mol) of 2,2′-bis(trifluoromethyl) benzidine (TFMB), 4.6 g (0.2 mol) of 4′4-dialminodiphenyl sulfone (4′4-DDS), 38.85 g (0.9 mol) of pyromellitic dianhydride (PMDA), and 6.56 g (0.1 mol) of 3,3′4,4′-biphenyl tetracarboxylic acid dianhydride (BPDA) were added to the flask for 24 hours of reaction at 25° C. to obtain a polyamic acid solution having a solid content of 15% by weight.

The polyamic acid solution was applied by spin coating on a glass plate serving as a substrate, and the coating was heated in a nitrogen atmosphere to a temperature range of 50° C. to 450° C. at a rate of 3° C./rain for 30 minutes to form a 10 μm-thick polyimide film on the glass plate. The resulting polyimide film was peeled off from the glass plate, and YI, CTE, and Tg of the film were measured. The results are shown in Table 1.

### Example 1 and Example 2

The same process as in Comparative Example 1 was performed, except that the compositions were wet as shown in Table 1 below, to obtain polyimide films. The resulting polyimide films were peeled off from the glass plate, and YI, CTE, and Tg of the films were measured. The results are shown in Table 1.

TABLE 1

| | | | | | | Fluorine |
|---|---|---|---|---|---|---|
| | | | | | | content |
| | Diamine | | | Dianhydride | | (% by |
| Classification | TEMB | 4′4-DDS | FDA | PMDA | BPDA | weight) |
| Comparative | 80 | 20 | 0 | 90 | 10 | 11.57 |
| Example 1 | | | | | | |
| Example 1 | 50 | 20 | 30 | 80 | 20 | 6.94 |
| Example 2 | 50 | 20 | 30 | 70 | 30 | 6.75 |

TABLE 2

| | | | Thermal | |
|---|---|---|---|---|
| | Molecular | Optical | characteristics | |
| | weight | characteristics | CTE | Tg |
| Classification | g/mol | YI | (ppm/° C.) | (° C.) |
| Comparative | 175,482 | 27 | 11 | 437 |
| Example 1 | | | | |
| Example 1 | 97092 | 17 | 16 | 456 |
| Example 2 | 121298 | 16 | 18 | 457 |

As shown in Table 2, in the case of Comparative Example 1, the content of PMDA was 90 mol %, and the molecular weight was 150,000 or more. In addition, it was confirmed that the YI was 20 or higher. In the case of Examples 1 and 2, the content of PMDA was reduced, and it was confirmed that the physical characteristics of the films were satisfactory when the content of PMDA was 80% by mole or less.

### Comparative Example 2 (PMDA 80% By Mole)

To a 1000 mL three-necked round-bottom flask substituted with nitrogen gas, 425 g of N-methyl-2-pyrrolidone (NMP) was added. In addition, 29.28 g (1 mol) of 2,2′-bis(trifluoromethyl) benzidine (TFMB), 33.53 g (0.8 mol) of pyromellitic dianhydride (PMDA), and 12.74 g (0.2 mol) of 3,3′4,4′-biphenyl tetracarboxylic acid dianhydride (BPDA) were added to the flask for 24 hours of reaction at 25° C. to obtain a polyamic acid solution having a solid content of 15% by weight.

The polyamic acid solution was applied by spin coating on a glass plate serving as a substrate, and the coating was heated in a nitrogen atmosphere to a temperature range of 50° C. to 450° C. at a rate of 3° C./rain for 30 minutes to form a 10 μm-thick polyimide film on the glass plate. The resulting polyimide film was peeled off from the glass plate, and the YI, CTE, and Tg of the film were measured. The results are shown in Table 4.

### Examples 3 to 5

The same process as in Comparative Example 1 was performed, except that the compositions were as shown in Table 1 below, to obtain polyimide films. The resulting polyimide films were peeled off from the glass plate, and the YI, CTE, and Tg of the films were measured. The results are shown in Table 4.

### Comparative Examples 3 and 4

The sample process as in Comparative Example 1 was performed, except that the compositions were as shown in Table 3 below, to obtain polyimide films. The resulting polyimide films were peeled off from the glass plate, and the YI, CTE, and Tg of the films were measured. The results are shown in Table 4.

TABLE 3

| | | | | | | Fluorine |
|---|---|---|---|---|---|---|
| | | | | | | content |
| | Diamine | | | Dianhydride | | (% by |
| Classification | TEMB | 4′4-DDS | FDA | PMDA | BPDA | weight) |
| Comparative | 100 | 0 | 0 | 80 | 20 | 13.80 |
| Example 2 | | | | | | |
| Comparative | 85 | 0 | 15 | 80 | 20 | 11.67 |
| Example 3 | | | | | | |
| Example 3 | 60 | 20 | 20 | 80 | 20 | 8.37 |
| Example 1 | 50 | 20 | 30 | 80 | 20 | 6.94 |
| Example 4 | 40 | 20 | 40 | 80 | 20 | 5.53 |
| Example 5 | 30 | 20 | 50 | 80 | 20 | 4.14 |
| Comparative | 45 | 0 | 55 | 80 | 20 | 6.09 |
| Example 4 | | | | | | |

TABLE 4

| | | | Thermal | |
|---|---|---|---|---|
| | Molecular | Optical | characteristics | |
| | weight | characteristics | CTE | Tg |
| Classification | g/mol | YI | (ppm/° C.) | (° C.) |
| Comparative | 164331 | 12 | 12 | 431 |
| Example 2 | | | | |
| Comparative | 177984 | 13 | 14 | 438 |
| Example 3 | | | | |
| Example 3 | 132482 | 14 | 15 | 458 |
| Example 1 | 97092 | 17 | 16 | 456 |
| Example 4 | 145481 | 17 | 18 | 463 |
| Example 5 | 149586 | 19 | 19 | 469 |
| Comparative | 185391 | 21 | 22 | 475 |
| Example 4 | | | | |

As shown in Table 4, in the case of Comparative Example 2 and Comparative Example 3, it was confirmed that the Tg was lower than 450° C. when the content of FDA was 0 or 15 moles. In the case of Comparative Example 4, when the content of FDA was 55% by mole, the Tg was 450° C. or higher that falls in a satisfactory range, but the YI and CTE were outside the desired ranges.

### Examples 6 to 10

The same process as in Comparative Example 1 was performed, except that the compositions were set as shown in Table 5 below, to obtain polyimide films. The resulting polyimide films were peeled off from the glass plate, and the YI, CTE, and Tg of the films were measured. The results are shown in Table 6.

### Comparative Examples 5 and Reference Example 1

The same process as in Comparative Example 1 was performed, except that the compositions were set as shown in Table 5 below, to obtain polyimide films. The resulting polyimide films were peeled off from the glass plate, and the YI, CTE, and Tg of the films were measured.

The results are shown in Table 6.

TABLE 5

| | | | | | | Fluorine |
|---|---|---|---|---|---|---|
| | Diamine | | | Dianhydride | | content |
| Classification | TEMB | 4′4-DDS | FDA | PMDA | BPDA | (wt %) |
| Comparative | 75 | 0 | 25 | 80 | 20 | 10.26 |
| Example 5 | | | | | | |
| Example 6 | 70 | 5 | 25 | 80 | 20 | 9.62 |
| Example 7 | 65 | 10 | 25 | 80 | 20 | 8.97 |
| Example 8 | 60 | 15 | 25 | 80 | 20 | 8.31 |
| Example 9 | 55 | 20 | 25 | 80 | 20 | 7.66 |
| Example 10 | 50 | 25 | 25 | 80 | 20 | 6.99 |
| Reference | 45 | 30 | 25 | 80 | 20 | 6.32 |
| Example 1 | | | | | | |

TABLE 6

| | | | Thermal | |
|---|---|---|---|---|
| | Molecular | Optical | characteristics | |
| | weight | characteristics | CTE | Tg |
| Classification | g/mol | YI | (ppm/° C.) | (° C.) |
| Comparative | 184331 | 21 | 16 | 457 |
| Example 5 | | | | |
| Example 6 | 145303 | 20 | 16 | 458 |
| Example 7 | 120347 | 19 | 17 | 458 |
| Example 8 | 91327 | 17 | 17 | 457 |
| Example 9 | 71298 | 16 | 18 | 459 |
| Example 10 | 56833 | 15 | 19 | 458 |
| Reference | 33423 | 20 | 22 | 458 |
| Example 1 | | | | |

As shown in Table 6, in the case of Comparative Example 5, the content of 4′4-DDS was 0% by mole, and the molecular weight was 150,000 or more. In the case of Reference Example 1, it was found that when the molecular weight was less than 50,000, the YI and CTE values were slightly reduced. When the content range of the 4′4-DDS containing a sulfonyl group is in a preferable range of 5% to 25% by mole, polyimide films having excellent optical and thermal characteristics and having appropriate molecular weights can be prepared.

### Comparative Examples 6 and Reference Example 7

The same process as in Comparative Example 1 was performed, except that the compositions were set as shown in Table 7 below, to obtain polyimide films. The resulting polyimide films were peeled off from the glass plate, and the YI, CTE, and Tg of the films were measured. The results are shown in Table 8. The measurement results of Examples 6 and 9 are shown together for comparison.

TABLE 7

| | Diamine | | | | | | Fluorine |
|---|---|---|---|---|---|---|---|
| | | 4′4- | | Dianhydride | | | content |
| Classification | TEMB | DDS | FDA | PMDA | BPDA | 6FDA | (wt %) |
| Comparative | 100 | 0 | 0 | 55 | 25 | 20 | 16.37 |
| Example 6 | | | | | | | |
| Example 6 | 70 | 5 | 25 | 80 | 20 | 0 | 9.62 |
| Example 9 | 55 | 20 | 25 | 80 | 20 | 0 | 7.66 |
| Comparative | 25 | 25 | 50 | 80 | 20 | 0 | 3.47 |
| Example 7 | | | | | | | |

TABLE 8

| | | | Thermal | |
|---|---|---|---|---|
| | Molecular | Optical | characteristics | |
| | weight | characteristics | CTE | Tg |
| Classification | g/mol | YI | (ppm/° C.) | (° C.) |
| Comparative | 140235 | 39 | 32 | 412 |
| Example 6 | | | | |
| Example 6 | 145303 | 20 | 16 | 458 |
| Example 9 | 71298 | 16 | 18 | 459 |
| Comparative | 131230 | 28 | 37 | 489 |
| Example 7 | | | | |

As shown in Table 8, when the fluorine content was 15% by weight or higher, carbonization occurred during the film manufacturing process, and thus the films had poor optical characteristics and low glass transition temperatures (Tg). When the fluorine content is 5% by weight or lower, the optical characteristics deteriorated due to a large number of charge transfer (CT) complexes, resulting in an increase in the total amount of FDA and 4′4-DDS. Accordingly, the CTE increased.

Therefore, it is concluded that when the fluorine content is within a range of 5% to 15% by weight, a film having satisfactory physical characteristics can be obtained.

What is claimed is:

1. A polyimide-based composition comprising a polyimide precursor and a solvent, the polyimide precursor comprising repeating units represented by Chemical Formulas 1 to 3: 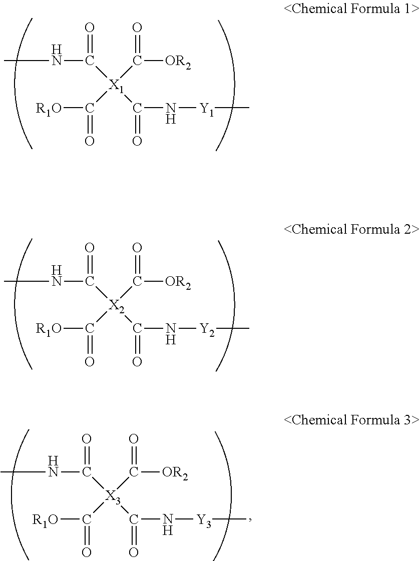
wherein, in Chemical Formulas 1 to 3,
X1 to X3 are tetravalent organic groups derived from a dianhydride monomer,
Y1 to Y3 are divalent organic groups derived from a diamine monomer,
at least one of X1 to X3 comprises a structure derived from a pyromellitic dianhydride,
Y1 to Y3 comprise a structure derived from at least one diamine monomer selected from the group consisting of aromatic diamines containing a fluorene group, aromatic diamines containing a sulfonyl group, and aromatic diamines containing a halogenoalkyl substituent, wherein Y1 to Y3 are structures different from each other, and
R1 and R2 are each independently hydrogen, deuterium, a substituted or unsubstituted C1-C30 alkyl group, a substituted or unsubstituted C2-C30 alkenyl group, a substituted or unsubstituted C6-C50 aryl group, or a substituted or unsubstituted C2-C50 heteroaryl group.

2. The composition according to claim 1, wherein the polyimide precursor comprises about 5% to about 15% by weight of fluorine.

3. The composition according to claim 1, wherein the polyimide precursor has a weight average molecular weight of in a range of about 50,000 to about 150,000.

4. The composition according to claim 1, wherein a molar ratio of the structure derived from the aromatic diamine containing a sulfonyl group to the structure derived from the pyromellitic dianhydride is in a range of about 1:0.20 to about 1:0.60.

5. The composition according to claim 1, wherein the structure derived from the pyromellitic dianhydride accounts for about 60% to about 80% by mole among all structures derived from dianhydrides in the X1 to X3.

6. The composition apparatus according to claim 5, wherein a structure derived from dianhydrides containing two or more aromatic rings accounts for about 20% to about 40% by mole among structures derived from all of the dianhydrides in the X1 to X3.

7. The composition according to claim 1, wherein the aromatic diamines containing a fluorene group account for about 60% to about 80% by mole among structures derived from diamines in Y1 to Y3.

8. The composition according to claim 7, wherein the aromatic diamines containing a sulfonyl group account for about 5% to about 25% by mole among structures derived from the diamines in Y1 to Y3.

9. The composition according to claim 8, wherein the aromatic diamines containing a halogenoalkyl substituent account for about 60% to about 80% by mole among structures derived from the diamines in Y1 to Y3.

10. The composition according to claim 1, wherein the diamine monomer containing a halogenoalkyl substituent comprises one or more selected from the group consisting of 2,2′-bis(trifluoromethyl) benzidine (FMB), 2,2-bis[4-(4-aminophenoxy) phenyl]hexafluoropropane (HFBAPP), 2,2-bis(3-amino-4-hydroxyphenyl) hexafluoropropane (BIS-AP-AF), and 1,3-diamino-2,4,5,6-tetrafluorobenzene (DRFB).

11. The composition according to claim 1, wherein the aromatic diamine containing a sulfonyl group comprises one or more selected from the group consisting of 4,4′-diaminodiphenyl sulfide (ASD), 4,4′-diaminodiphenyl sulfone (DDS), bis[4-(4-aminophenoxy)phenyl]sulfone (BAPS), and 2,2-bis[4-(3-aminophenoxy) benzene]sulfone (m-BAPS).

12. The coating structure according to claim 6, wherein the dianhydride containing two or more aromatic rings comprise one or more selected from the group consisting of 3,3′,4,4′-benzophenonetracarboxylic dianhydride (BTDA), 3,3′,4,4′-biphenyl tetracarboxylic acid dianhydride (BPDA), 2,2-bis(3,4-anhydrodicarboxyphenyl)-hexafluoropropane dianhydride (6FDA), and 4,4′-oxydiphthalic anhydride (ODPA), and 3,3′,4,4′-diphenylsulfone-tetracarboxylic dianhydride (DSDA).

13. The composition according to claim 1, wherein the solvent comprises one or more selected from the group consisting of: amide solvents including dimethylformamide (DMF), dimethylacetamide (DMAC), and n-methylpyrrolidone (NMP); ketone solvents including acetone, methyl ethyl ketone (MEK), methyl isobutyl ketone (MIBK), cyclopentanone, and cyclohexanone; ether solvents including tetrahydrofuran (THF), 1,3-dioxolane and 1,4-dioxane; symmetrical glycoldiethers including methyl acetate, ethyl acetate, butyl acetate, γ-butyrolactone, α-acetlactone, β-propiolactone, δ-valerolactone, methyl monoglyme(1,2-dimethoxyethane), methyldiglyme(bis(2-methoxyethyl)ether), methyltriglyme(1,2-bis(2-methoxyethoxy)ethane), methyltetraglyme(bis[2-(2-methoxyethoxyethyl)]ether), ethyl monoglyme(1,2-diethoxyethane), ethyl diglyme(bis(2-ethoxyethyl)ether), and butyl diglyme(bis(2-butoxyethyl) ether); and other ethers including dipropylene glycol methyl ether, tripropylene glycol methyl ether, propylene glycol n-propyl ether, dipropylene glycol n-propyl ether, propylene glycol n-butyl ether, dipropylene glycol n-butyl ether, tryrene glycol n-propyl ether, Propylene glycol phenyl ether, dipropylene glycol dimethyl ether, 1,3-dioxolane, ethylene glycol monobutyl ether, diethylene glycol monoethyl ether, diethylene glycol monobutyl ether, and ethylene glycol monoethyl ether.

14. A polyimide film made from the polyimide-based composition of claim 1.

15. The polyimide film according to claim 14, wherein the polyimide film is obtained through about 1 to about 60 minutes of heating performed in a temperature range of about 200° C. to about 450° C.

16. The polyimide film according to claim 14, wherein the polyimide film has a thickness in a range of about 10 to about 15 μm, a yellowness index (YI) of about 20 or less, a Tg of about 450° C. or more, and a CTE of about 20 ppm/° C. or less.

17. A display device comprising the polyimide film of claim 14.
